(19) United States
(12) Patent Application Publication
(10) Pub. No.: US 2007/0100854 A1
(43) Pub. Date: May 3, 2007

(54) Method of providing a validatable data structure

(75) Inventors: Antonio Lain, Bristol (GB); Patrick Goldsack, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/490,947

(22) Filed: Jul. 21, 2006

(30) Foreign Application Priority Data
Oct. 29, 2005 (GB) 0522100.7

(51) Int. Cl. G06F 7/00

(52) U.S. Cl. 707/100

(57) ABSTRACT

A method of providing a validatable data structure having a changeable part and an unchangeable part having respective content is described. The method comprises incorporating, in the unchangeable part, an identifier identifying the changeable part.

### FIELD OF THE INVENTION

The invention relates to a method of allowing validation of a data structure.

### BACKGROUND OF THE INVENTION

Authentication of data using digital signing is well known whereby information is uniquely summarized, for example using hashing, and a digital signature is computed over that summary and attached to the information such that a third party can identify whether the signing entity is the correct entity and the information has not been changed. In one implementation an extensible mark-up language (XML) signing scheme of this nature is provided in which, additionally, parts of a document that do need to be signed are identified, for example, via applying an XPath transform to the original document before summarizing it.

### BRIEF SUMMARY OF THE INVENTION

A method of providing a validatable data structure having a changeable part and an unchangeable part having respective content comprises incorporating, in the unchangeable part, an attribute name identifying the changeable part and a policy specifying who can change that part and what changes are allowed. The changed part could further introduce new changeable parts and policies.

### BRIEF DESCRIPTION OF THE DRAWINGS

Embodiments of the invention will now be described, by way of example only, with reference to the drawings, of which:

FIG. 1 is a schematic diagram of a distributed computer system in relation to which the method can be implemented;

FIG. 2 is a schematic diagram showing a data structure in relation to which the method can be implemented;

FIG. 3A is a flow diagram showing the steps performed by an originator;

FIG. 3B is a flow diagram showing the steps performed by a scheduler;

FIG. 3C is a flow diagram showing the steps performed by an executor;

FIG. 4 is a flow diagram illustrating in more detail steps performed by an originator;

FIG. 5 is a flow diagram showing in more detail steps performed by a scheduler;

FIG. 6 is a flow diagram illustrating in more detail steps performed by an executor; and

FIG. 7 is a block diagram of a computer apparatus configured to implement the method.

### DETAILED DESCRIPTION OF THE INVENTION

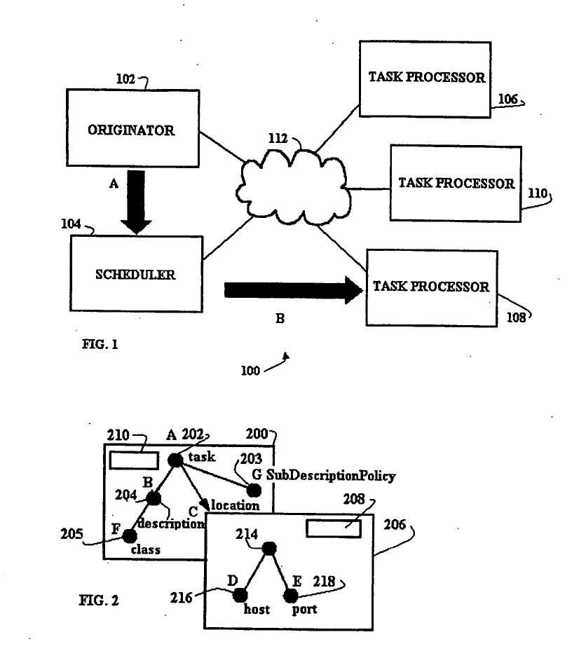

In overview the method and apparatus described herein can be understood with reference to FIGS. 1 and 2 which show respectively a distributed computer system and a data structure in relation to which the method is implemented.

Referring firstly to FIG. 1 a distributed computer system designated generally 100 comprises a plurality of distributed computing entities 102, 104, 106, 108, 110. The entities are connected by a network shown generally at 112 allowing communication between the entities. As a result a collection of computing tasks may be distributed between the entities with different tasks carried out by different entities communicating via the network 112. Because the entities communicate via a network it is necessary to ensure that appropriate security features are implemented for example to ensure the integrity and authenticity of information and instructions communicated between the entities.

By way of explanation one specific example showing operation of the method described herein will be described with reference to the system 100 shown in FIG. 1 in which the distributed computer system 100 includes, as entities, an originator 102, a scheduler 104, and first, second and third task processors 106, 108, 110. The originator originates a data structure comprising a description defining one or more tasks to be implemented across the distributed system. However in the case that the originator of the description does not have all the details required to complete the description it is necessary to delegate to a separate entity—in this case the scheduler 104—to complete the description. For example the scheduler may be required to allocate and deploy one or more of the tasks to specific entities in the distributed system requiring corresponding customization of the description according to the chosen location by the scheduler in which the task will eventually execute.

One implementation where such a system may be required is in a sales environment where a salesman completes an order for a customer by completing an online form in which he specifies the ordered product. However the salesman may not have pricing information, nor information about where the pricing information can be derived. The document capturing the details of the order is codified as a hierarchical attribute tree and submitted by the salesman at the originator computing entity 102. The document has some changeable part to be filled in including the pricing details by the order processing software at the remote scheduler 104 comprising the front end of the order processing system. The scheduler or front end therefore needs to establish which further remote entity can obtain the pricing information (for example task processor 106, 108 or 110), to implement the “pricing task” and will then deploy the task to the appropriate task processor.

However where the scheduler is partially trusted it is undesirable to require the originator to validate every amendment made by the scheduler. On the other hand, it is important to ensure that the scheduler can only change the required part of the data structure—“the changeable part”—and none other such that a third party can ensure that the remainder or “original intent” of the description—“the “unchangeable part” has not been compromised. For example where the scheduler is only be permitted to add appropriate attributes defining the location at which the task is implemented it is desirable that third parties should be able to identify whether any additional, impermissible changes, have been made by the scheduler such as the nature of the task itself. In an optimization it is further desirable that a third party can establish that only the scheduler, and not some unauthorized party, has made permissible changes.

As discussed in more detail below, the appropriate security features can be implemented by providing extensions to the language used to describe the data structure, and a specific example is presented in relation to the SmartFrog language which will generally be known to the skilled reader such that detailed description is not required here. However it will be appreciated that appropriate extensions can be implemented in any desired language. The SmartFrog language is described in at http://www.smartfrog.org.

An exemplary data structure to which the method described herein can be applied can be understood with reference to FIG. 2. In particular a data structure in the form of a description 200 comprises a hierarchical component description of sub-structures which can be represented as a tree including internal nodes A, B, C, named “task”, “description” and “location” reference numerals 202, 204, 214. Each node contains a set of attribute/value pairs in which the value is either another internal node or a leaf node comprising a simple value which can be resolved at ?? time such as for example, an integer or a string in this case leaf nodes G, F, D, E named “subDescriptionPolicy”, “class”, “host” and “port” reference numerals 203, 205,216, 218. It will be seen that the referenced internal nodes such as B and C in turn point either to simple values or can point to further internal nodes again. As a result the data structure provides a tree-structure which can be self-contained or contain a sub-description which can be extended by reference to other nodes. In the case shown in FIG. 2, node A “task” is a parent node, attribute G “subDescriptionPolicy” is a simple valued, child internal node, child internal node B “description” contains an attribute F “class” that has a simple value and child “internal” node C “location” contains a sub-structure comprising attributes D “host” and “port” 216 and 218 including simple values. As discussed in more detail below node C can be subsequently refined by a scheduler to add or vary the value of D and E

Reverting to the distributed computer system 100 shown in FIG. 1, the originator 102 originates a data structure 200 of the type shown in FIG. 2 according to the method described herein including an unchangeable part and a changeable part which the scheduler 104 is able to change for example by adding appropriate location information. For example nodes “task”, “description” and simple values “subDescriptionPolicy” and “class”, and the attribute name “location” may represent information comprising the unchangeable parts such as tasks to be completed whereas the value assigned to node “location”, that is the contents of subdescription 206 may comprise a changeable part which the scheduler is permitted to change by adding the location information “host and port. For example in the case of the sales order as discussed above the changeable part comprises sub-description 206 allowing the front end of the order processing system to invert the host and port name identifying the appropriate task processor for obtaining pricing details. It will be noted that the name, “location” of the node C is not inside its sub-description 206 and hence is changeable.

Once the data structure is originated at originator 102 it is forwarded to the scheduler as shown by arrow A in FIG. 1 in order that the scheduler can add the location information. However in order to ensure that only the changeable part can be modified by the scheduler and in particular to ensure that any other modifications will be detected, such that the validation of the data structure is possible, the name for the changeable part, includes an identifier or “marker” to show its value is changeable. Because the marker is associated with the name they are incorporated in the unchangeable part. For example, referring to FIG. 2, within the data structure 200 the name “location” incorporates a marker The exact form is discussed in more detail below and comprises an appropriate extension of the language in which the data structure is expressed.

Upon receipt of the data structure 200 the scheduler first authenticates this data structure using its own global policy, then modifies the changeable part 206 as appropriate and, for example, deploys the data structure via the communications network 112 to the appropriate task processor which it may itself have scheduled, for example task processor 108 as shown schematically by arrow B. For example the scheduler may identify task processor 108 as the appropriate processor for incorporating the pricing information and identified accordingly by updating the host and port leaf nodes in sub-description 206.

Task processor 108 then validates the received data structure. In particular the task processor will carry out checks to ensure that the content of the data structure corresponds to an unchangeable part validator value associated with the original data structure content such as a global unchangeable part signature added by the originator, shown schematically at 210 in FIG. 2. Typically the signature 210 is created at the originator by performing a pre-determined operation on the content of the data structure, for example a hash function operation and the task processor 108 repeats the same operation as a function of the received content to ensure that the result returned by the operation corresponds to the signature 210 as will be well known to the skilled reader.

In order to ensure that permissible modifications by the scheduler to the changeable part do not return a correspondingly changed value for the computed validator value or signature at the task processor, both the originator 102 and the task processor 108 compute the signature as a function of a fixed or common value associated with the changeable part at node “location” and which is independent of the specific content of node “location”. As a result the data structure as a whole can be authenticated even if changes are made to the changeable part.

In a further optimization it is desirable to ensure that the correct party, i.e. the scheduler in the present example was the party that modified the changeable part 206 and the content of the changes satisfy certain policy. This is achieved by further associating a changeable part security policy 212 with the parent node “task” of node “location” for example “SubDescriptionPolicy” at leaf node G 203 or in any other appropriate manner. Once again the policy cannot be altered as it is in the unchangeable part. The policy specifies a security requirement allowing checking of the authenticity of a signature 208 added by a changing entity and the nature of those changes as described in more detail below. In particular, upon modification of the data structure the scheduler 104 adds its signature 208 to the changeable part. The task processor 108 then needs to validate also the signature 208 associated with the independent data structure that forms the changeable part at node “location”, using the policy specified in the non-changeable part. to ensure that the scheduler was authorized to make that kind of modification.

As a result embedded sub-descriptions such as the changeable part 206 can be checked for authenticity and integrity by other components in a distributed computer system as appropriate without requiring validation by the originator of the initial description. where the task processor trusts the originator but not the scheduler.

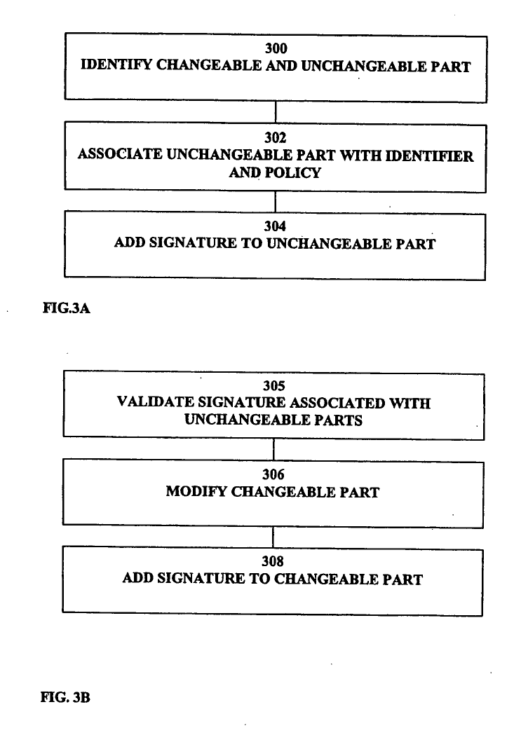

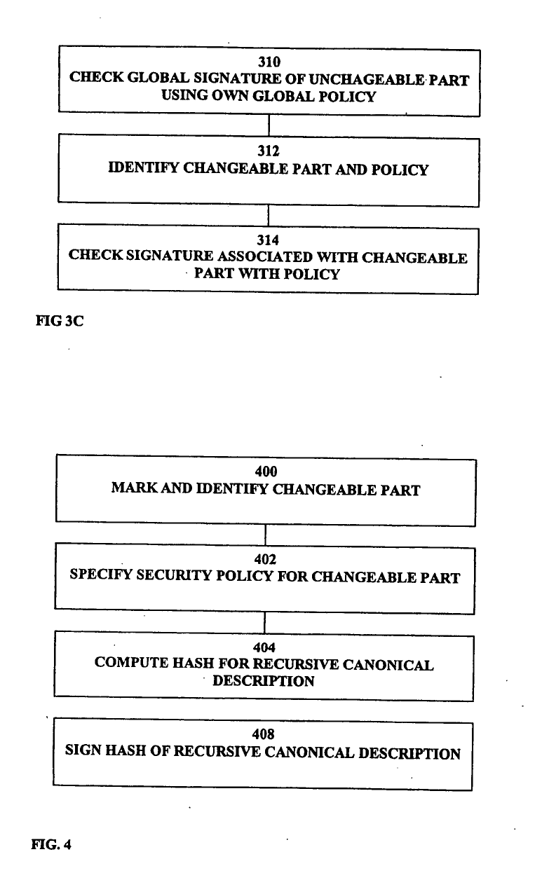

The steps performed according to the method described herein can be further understood in overview with reference to the flow diagrams of FIGS. 3A, 3B and 3C which illustrate the steps taken at an operator, a scheduler and an executor such as a task processor respectively.

At step 300 the originator identifies changeable and unchangeable parts of the data structure and at step 302 an identifier and policy are associated with the changeable part, placed in the unchangeable part. At step 304 a global signature is computed for the data structure and added to the unchangeable part. The signature is computed as a function of the content of the data structure including a fixed value associated with the changeable part.

Referring to FIG. 3B, the scheduler, after validating the unchangeable part of the data structure at step 305 processes the data structure in particular by modifying the changeable part at step 306. At step 308 the scheduler further adds its signature to the changeable part.

Turning to FIG. 3C, at step 310 the task processor first checks the global signature associated with the unchangeable part using its own global policy. In particular the task processor performs the same operation as was performed at the originator on the content of the data structure including the fixed value associated with the changeable part. As long as none of the unchangeable part content of the data structure has been changed, the signature computed by the task processor will match that attached to the data structure. At step 312 the task processor identifies from the identifier the changeable part of the data structure and the associated policy and at step 314 the task processor further checks that the signature added by the scheduler to the changeable part is authentic by matching it with the policy associated with the changeable part to ensure that the scheduler was authorized to carry out the changes to the changeable part. In addition the policy may specify the nature of the changes that can be made in which case, at step 316, the task processor checks that the content and changeable part respect the associated permitted changes in the policy.

The manner in which validation is carried out can be in any appropriate manner. For example a system using public-private key pairs can be implemented as is well known to the skilled reader and so not described in detail here. In summary, however, each party has a private key value which can be combined using an appropriate operator with a hash to provide a unique signature which is a function both of the identity of the signing party, i.e., its public key, and the content of the data structure allowing a third party to verify both the identity of the signing party and integrity of the content of the original data structure.

As a result of this approach non-fully trusted agents can partially modify or propagate a data structure such that a description is modified in a controlled way. A third party can then validate that the original intent of the description has not been compromised by the transformation such that certain parts of the description cannot be changed. Furthermore the immutable or unchangeable part contains the identifiers identifying the changeable part and can further specify who can change the changeable parts and the nature of these changes. Security is further enhanced as any attempt to modify the data structure such that other parts appear to be changeable parts will fail because this will alter the content of the unchangeable part of the description and hence the global signature check will fail.

Yet, further part of the data structure can be replaced by appropriate unique values representing the content which, when the global signature is computed, return a validated result meaning that parts of the data structure which are not required for certain entities within a distributed system or which unnecessarily increase the size of a data structure to be delayed, can be replaced by the unique value.

The steps performed at the originator entity 102 can be understood in more detail with reference to flow diagram of FIG. 4. As described above, a data structure to be operated on within a distributed computing environment comprises a description including an unchangeable part and a changeable part referred to here as a signed part identified by an identifier within the unchangeable part. In particular the data structure can comprise a hierarchical description which can be represented as a tree in which each internal node contains a list of attribute name value pairs, the attribute names being unique in the context of the node and the values being restricted to either simple values or other internal nodes.

In the context of data structure 200 of FIG. 2, this hierarchical description of the unchangeable parts can be represented as:

Listing 1

{

task extends {

subDescriptionPolicy “(<scheduler_pub_key>)”;
description extends {

class “myTaskImpl.class”;

}
location extends SIGNED {

}

}
}

In addition the policy may specify the nature of the changes that can be made in which case, at step 316, the task processor checks that the content and changeable part respect the associated permitted changes in the policy.

In order to secure the data structures of this hierarchical form and in particular a global signature, the originator computes a recursive canonical representation of the description. In particular the function effectively works up the hierarchical tree and concatenates a canonical representation of simple values associated with nodes where available or, if the value is another internal node seeks the extended simple value. The concatenation can comprise, for example, a hash function which will be well known to the skilled reader as having the property of returning a unique, repeatable “digest” value as a function of and shorter than the data content, such that any change to the content is detectable when the operation is repeated on the changed content as a different hash value will be returned.

As a first step, 400, therefore, those parts of the description which it is permissible for a remote entity to change (for example the location information to be changed by a scheduler in the example provided above) are identified by inserting the identifier “signed” in the unchangeable part. The keyword “signed” is introduced as a qualifier to “extends” and represents that the value of the extended attribute is a node that has the property “signed”, that property indicating that the node is “opaque” when its enclosing description, that is, the description of which it forms a changeable part, including its parent node is canonicalized. Hence when the recursive hashing process is carried out, it terminates at the signed node and instead a fixed value associated with the node is operated on by the hashing function. Therefore, the “top level” description can be validated independent of the content of the sub-description.

At step 402 the policy, comprising a security requirement in relation to the signed sub-description allowing requirements relating to authorized modifiers and modifications of the sub-description to be dictated is specified; in this case valid signers of the sub-description can be specified for example by reserving an appropriate attribute name such as “subDescriptionPolicy” and providing an attribute with that name in the immediately enclosing node of the signed nodes. The value of the attribute specifies a security requirement for the signer, for example specifying its public key and can be implemented in any appropriate manner for example using simple path constraints (SPC's) as described in a co-pending patent application commonly assigned herewith and entitled “A method of authorising a computing entity” filed on the same day under reference no. HP200504148 This may be represented as shown in the previous Listing 1

This policy may identify, for example, which parties may modify the changeable part and any other appropriate security features such as the possible modifications available, a timescale of modification and so forth. As discussed below the modifier for example the scheduler must also take various security-related steps including signing the changes which must match with the policy for the eventual data structure to be validated by a third party entity.

Once the policy requirements and marked parts are included in the unchangeable part, the concatenation step 404 is carried out by computing a hash of the description.

To summarize, the hash value computed in step 404 can be obtained recursively applying the following example function:

Listing 2

String canonical(Node n) {

result = “{\n”;

for every attribute/value pair (attr,val) in n {

if val is a Node {

if val is “signed” {

///ignore val, always use the same string
result = concat(result,
attr, “extends signed { };\n”);

} else {

// use val, since the node is not “opaque”

result = concat(result,
attr, “extends”, canonical(val), “;\n”);

}

} else { // it is a basic type
result = concat(result, attr, “ “,
canonicalBasic(val), “;\n”);

}

}

return hashString(concat(result, “}”));
}

As a result it will be seen that the output comprises a validator value or validator valve precursor in the form of a hash string comprising an operation performed recursively on the simple values attached to each node traversing the tree from the “bottom up” to find simple values associated with nodes where required, assuming a character encoding, can be converted to a byte array that can be signed using a standard approach. However, this is not carried out for find nodes for which a fixed or common value, for example, the hash of the string “extends Signed { }” is obtained although any fixed value that cannot be a hash of a non-signed description can be adopted. The hash string can be computed in any appropriate manner for example using an approach as follows:

Listing 3

String hashString(String str) {

byte[ ] strBytes = obtain standard binary representation of str

(e.g., assuming UTF-8 character encoding)

byte[ ] hash = compute a hashing function of strBytes (e.g., SHA-1)
String hashBase64 = compute a string representation of hash
(e.g., base 64 encoding)
Return concat(“HASH-SHA-1#,hashBase64, “#”);

}

Of course any appropriate manner of obtaining a unique digest of the information content of the data structure may be adopted as will be well known to the skilled reader. The hash is then signed at step 408.

The manner in which the function performs recursively in relation to a hierarchical data structure can further be understood with respect to the following example in the context of Listing 1 and the hierarchy represented therein and in FIG. 1 whereby node “description” contains a simple-valued attribute “class” and is a child of node “task” which in turn also contains a simple valued attribute named “subDescriptionPolicy” and a “signed” attribute with name “location” that can be further refined later on with a node value. Also where we assume that hashString of node “description”'s content ({\nclass “myTaskImpl.class”;\n}”) is HASH-SHA-1#sdsdasdasd# and hashString of a “signed” node always return a constant value, i.e., independent of its contents, HASH-SHA-1#efefefefef#, we can represent this:

Listing 4

{
task extends {

subDescriptionPolicy “(<scheduler_pub_key>)”;

description extends HASH-SHA-1#sdsdasdasd#;

location extends SIGNED HASH-SHA-1#efefefefef#;

};

}

Then after the second level “canonical” function call, where we assume that hashString({\nsubDescriptionPolicy “(<scheduler_pub_key>)”;\n description extends HASH-SHA-1#sdsdasdasd#;\n location extends SIGNED HASH-SHA-1#efefefefef#;\n}) returns HASH-SHA-1#errwerwsd#, we obtain:

Listing 5

{

task extends HASH-SHA-1#errwerwsd#;

}

Applying hashString again we obtain HASH-SHA-1#wewewew#

It will be seen, therefore, that an embedded sub-description, for example description extends {class “myTaskImpl.class”;} can be replaced by its hash value such that, when the description as a whole is hashed the same hash result will be provided. For example by replacing description extends {class “myTaskImpl.class”;} with description extends HASH-SHA-1#sdsdasdasd# the same result is returned whilst allowing validation of the “top level” description.

Turning now to FIG. 5, when a authorized modifier such as a scheduler receives the data structure then, at step 500 the authorized party takes a permissible step such as modifying the changeable part by adding to it attributes host and port identifying where the task will be deployed:

Listing 8

{

task extends {

subDescriptionPolicy “(<scheduler_pub_key>)”;
description extends {

class “myTaskImpl.class”;

}
location extends SIGNED {

//added by the scheduler
host “xyz.com”;
port 3080;

}

}

It will be seen that upon validation of this the same hash result will be changed following addition of the attribute as would have been returned for listing 1.

In order subsequently to allow authentication by a third party validating entity, the modifying entity i.e. the scheduler additionally computes a signature in step 502 with a hash of the canonical representation of the new value assigned to the changeable part and its private key attaching any other security credentials required to validate the policy associated with the sub-description. That signature and credentials are attached to the node at step 504 for validation against the policy by a third party entity.

At a validating entity, it is necessary to check that the immutable parts of the description have not been changed, and were created by an authorized party (the originator) and that the changeable parts were changed by an authorized party (the scheduler) and in an authorized manner. It will be noted that although, in the embodiment described here, the validating party is treated as a party executing tasks within the description for example as allocated by the scheduler, any remote third party, for example including the originator itself, can perform validations steps as appropriate.

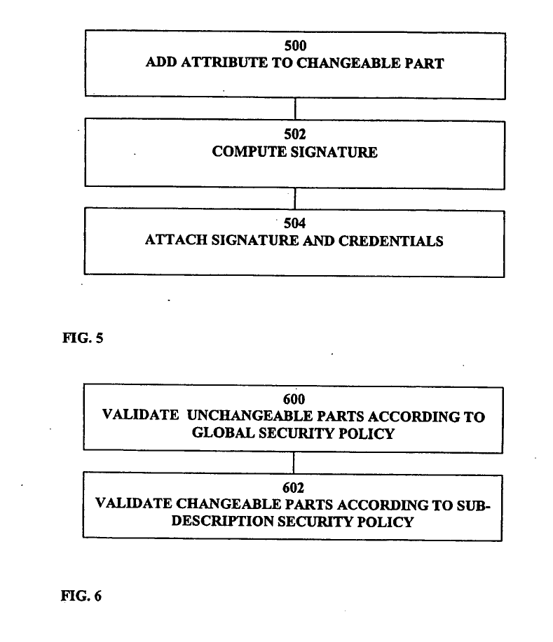

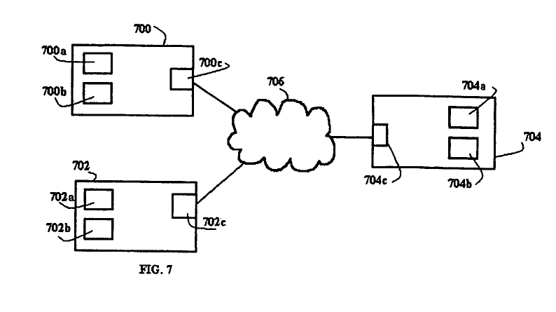

Referring to FIG. 6, the validating entity, therefore, first validates the original intent of the description at step 600 by checking that the unchangeable part has not been changed. In particular a hash is obtained to validate the global signature of the description, performed on the content of the data structure ignoring the “signed” sub-description and simply using the fixed values associated with those sub-descriptions. For example this check can be carried out in the context of any “global” security policy that it is desired to enforce as follows:

Listing 9

// invoking first validate(root_description, top_signature, global_policy)
// validates that a given description is correctly signed
validate(Node n, Signature sig, SecurityPolicy pol) {

hsh = canonical(n);
checkSignature(hsh, sig, pol);
validateSubDescription(n);

}

At step 602 the changeable parts are validated according to the associated sub-description security policy, in particular checking that the signature added by a modifying party is verifiable against the specified policy:

Listing 10

//traverses the description finding signed sub-descriptions
that need checking
validateSubDescriptions(Node n) {

subDescriptionPolicy =
n.getAttributeValue(“sfSubDescriptionSigner”);
for every attribute/value pair (attr, val) in n {

if val is a Node {

if val is “signed” {

validate(val, val.getSignature( ).subDescriptionPolicy)
}else {

validateSubDescription(val);

}

}

}

}
//”conventional” check that a signature verifies a hash and a policy
checks ignature(Hash hsh, Signature sig, SecurityPolicy pol) {

If we cannot verify “sig” with the given “hsh” or
the signer does not satisfy “pol” {

RAISE “bad signature” exception;
}

}

In addition to verifying the identity of the modifying party, additional checks can be carried out dependent on the sub-description security policy such as ensuring that the type of attribute added to the changeable part is correct and so forth as appropriate. It will further be noted that, dependent on the sub-description policy, the scheduler may itself be able to modify the changeable part recursively such that, in its modified form, it too includes unchangeable and changeable parts, for example, in the case where the scheduler is able to include some of the required modifications but must delegate other of the modifications to another entity such as a further scheduler. In particular the scheduler can introduce attributes with the SIGNED property in the changeable part and define different policies for them. In that case, of course, the task processor or processors will validate the changeable part recursively in a corresponding manner.

The manner in which the steps described above are carried out in relation to the specific example described with reference to FIGS. 1 and 2 will now be discussed. In particular, where an originator is not able to complete a description but requires input from a scheduler as to the allocation and deployment of certain tasks, the approach described herein can be adopted without requiring additional validation checks by the originator yet allowing third party entities to ensure that only permissible modifications have been made, and those by authorized parties. For example the originator may only want the scheduler to perform annotations in the description of where “task” should be deployed by attaching a signature to the description in Listing 1

As a result a scheduler is able to annotate location information for task (“location extends SIGNED{ }” but cannot modify other parts of task such as “description extends{ . . . ”. In addition the originator has identified the scheduler as the party permitted to make those changes by including the “(<scheduler_public_key>)” as part of the security policy referred by attribute “subDescriptionPolicy”. As a result the scheduler can modify the sub-description and attach its own signature as we saw in Listing 8

Following modification it will be seen that the host name and port number for specifying the location are included together with the signature attached by the scheduler.

A third party deploying the component, for example xyz.com at port number 3080, validates the top description using the global security policy as described above and this will not be affected by the changes to “location extends”. A recursive “validate” call is then carried out for the “location” sub-description using the “Scheduler_public_key” as a requirement for the signature validation. As long a match is identified then the changes of the modifying party can be authenticated, however if the scheduler modifies any material outside “location” the top level signature will no longer validate. In addition a new top level signature cannot be created by the scheduler as this can be excluded by the global security policy.

It will be appreciated that the manner in which the security policies are communicated and implemented, and the manner in which the hashing and signing processes are carried out can be adopted using any appropriate known technique. In addition any appropriate language extension or modification can be implemented for signing and changeable parts yet further as an alternative to the Smart Frog language any appropriate language can be introduced. In the context of the Smart Frog language the “standard” transformation phase is associated with a compellation of a description, such as type and link resolution, function evaluation and so forth are performed in the conventional manner as will be understood by the skilled reader such that specific description in is not required. The data structure can take any desired form and may be non-hierarchical, and the content can be validated using any appropriate hashing or concatenation or other technique.

It will be appreciated that the distributed computing system and the individual entities thereof can be any appropriate platform or system and any implementation, task or process and are not limited to the originator/scheduler/executor example set out above. For example referring to FIG. 7 each remote entity may comprise a conventional computing entity 700, 702,704 including respectively a data processor 700A, 702A, 704A, a memory 700B, 702B, 704B and an input/output interface for sending and receiving communications between the entities 700C, 702C, 704C. Communication may be by via any appropriate network 706 such as a local area network (LAN), the Internet or any other appropriate means. It will further be seen that each of the individual entities may be in a common physical location but comprise individual trusted entities such that security measures of the type described above are required to validate communications between them. For example each of the entities may comprise a java virtual machine (JVM) residing on one or more common platforms.

As a result of the arrangement described herein various advantages are achieved. By providing explicit support in the description language to control canonicalisation, and combining this with a recursive signing strategy, constrained and safe modifications to sub-descriptions are allowed. Furthermore signed descriptions can be compressed by replacing non-relevant sub-descriptions by their hashes without affecting the signatures of the enclosing descriptions or requiring resignature of the closing descriptions. Furthermore it can be ensured that modifications are carried out by entities specified by the originator facilitating the development of highly decoupled systems, where partially trusted agents can take autonomous decisions on certain aspects of the system without compromising overall security.

1. A method of providing a validatable data structure having a changeable part and an unchangeable part having respective content, the method comprising incorporating, in the unchangeable part, an identifier identifying the changeable part.

2. A method as claimed in claim 1 in which the identifier is associated with an attribute name in the unchangeable part corresponding to the changeable part.

3. A method as claimed in claim 1 further comprising incorporating, in the unchangeable part, a policy determining the circumstances in which the changeable part may be changed.

4. A method as claimed in claim 3 in which the policy determines what entities are authorized to change changeable part.

5. A method as claimed in claim 3 in which the policy determines what changes may be made to the changeable part.

6. A method as claimed in claim 1 further comprising computing an unchangeable part validator value as a function of the content of the unchangeable part and including the validator value in the data structure.

7. A method as claim 6 in which an unchangeable part validator value is further computed as a function of a content independent representation of the changeable part.

8. A method as claimed in claim 1 in which the data structure comprises a component description.

9. A method as claimed in claim 1 in which the data structure is arranged hierarchically as one or more descending generations of parent and child sub-structures including at least one sub-structure corresponding to an unchangeable part and at least one sub-structure corresponding to a changeable part.

10. A method as claimed in claim 9 in which an unchangeable part validator value is computed commencing at the last generation as a function of child sub-structure content to obtain a child validator value and then as a function of parent content and the child validator value for the or each ascending generation.

11. A method as claimed in claim 9 in which, where a child sub-structure comprises a changeable part, the identifier is associated with the parent to the child sub-structure.

12. A method as claimed in claim 9 in which, if an identifier is associated with a parent, the unchangeable part validator value is computed independent of the content of the child sub-structure.

13. A method as claimed in claim 1 further comprising the step of changing the changeable part.

14. A method as claimed in claim 13 further comprising the step of changing the changeable part to incorporate a changeable part and an unchangeable part, the unchangeable part incorporating an identifier identifying the changeable part.

15. A method as claimed in claim 13 further comprising the step of incorporating, in relation to the changed part, a signature identifying the changing party.

16. A method as claimed in claim 6 further comprising validating the data structure by recomputing an unchangeable part validator value as a function of the content of the unchangeable parts and comparing the recomputed validator value with the value included in the data structure.

17. A method as claimed in claim 15 further comprising validating the data structure by comparing a signature contained in a sub-structure comprising a changeable part with a policy associated with the changeable part.

18. A computer readable medium containing instructions arranged to operate a processor to implement the method of claim 1.

19. An apparatus for providing a validatable data structure comprising a processor configured to operate under instructions contained in a computer readable medium to implement the method of claim 1.

20. An apparatus for providing a validatable data structure having a changeable part and an unchangeable part having respective content, the apparatus including a processor configured to incorporate, in the unchangeable part, an identifier identifying the changeable part.
